(19) United States
(12) Patent Application Publication
(10) Pub. No.: US 2006/0277978 A1
(43) Pub. Date: Dec. 14, 2006

(54) Viscosity sensor system

(76) Inventors: Bernhard Jakoby, Lint (AT); Matthias Buskies, Eningen (DE); Monika Scherer, Reutlingen (DE)

Correspondence Address: KENYON & KENYON LLP, ONE BROADWAY, NEW YORK, NY, 10004, US

(21) Appl. No.: 10/566,808

(22) PCT Filed: Jul. 7, 2004
(86) PCT No.: PCT/DE04/01446

§ 371 Date: Jul. 12, 2006

(30) Foreign Application Priority Data
Jul. 28, 2003 (DE) 103342419

(51) Int. Cl. G01N 11/16

(52) U.S. Cl. 73/54.02; 73/54.41

(57) ABSTRACT

A viscosity sensor system for measuring the viscosity of a liquid and at least one additional property of the liquid using a piezoelectric viscosity sensor device that is situated completely in the liquid that is to be measured, and that has: electrical contact points for an electrical controlling of volume oscillations on its surface, these contact points being resistant in relation to the liquid; first electrical supply lines that are resistant in relation to the liquid and that are connected on the one hand with a control/evaluation electronics unit situated outside the liquid and on the other hand with the contact points on the surface of the viscosity sensor device; and a second sensor device for acquiring the at least one additional property of the liquid, this second device being provided on the surface of the viscosity sensor device and having electrical contact points on the surface of the viscosity sensor device for an electrical controlling, these electrical contact points being resistant in relation to the liquid; and second electrical supply lines that are resistant in relation to the liquid and that are connected on the one hand to the control/evaluation electronics unit situated outside the liquid and on the other hand to the contact points of the second sensor device.

### FIELD OF THE INVENTION

The present invention relates to a viscosity sensor system.

### BACKGROUND INFORMATION

In the monitoring of liquids, in particular liquid materials used in engine operation such as motor oil, a number of chemical and physical properties of the liquid can be used to monitor its “state”. An important criterion for monitoring the current state of the liquid is its viscosity η, which can be measured using a viscosity sensor.

For the measurement of viscosity, piezoelectric thickness shear vibrators, made for example of quartz, have long been used. See for example S. J. Martin et al., Sens. Act. A 44 (1994), pp. 209-218. If such a thickness shear vibrator is immersed in a viscous liquid, the resonance frequency of its natural oscillation, and its damping, change in a manner dependent on the viscosity and the density of the viscous liquid. Because for typical liquids the density varies much less than does the viscosity, practically speaking such a component acts as a viscosity sensor.

German Published Patent Application No. 101 12 433 discloses a viscosity sensor system having a piezoelectric sensor device that is situated entirely in the liquid that is to be measured and that has electrical contact points for an electrical control unit that are resistant in relation to the liquid, and having electrical supply lines that are resistant in relation to the liquid and that are connected on the one hand to a control and evaluation electronics unit outside the liquid, and on the other hand to the contact points of the sensor device, by a suitable conductive glue provided with metallic particles.

Because in most liquids the viscosity is strongly temperature-dependent, it is necessary to simultaneously acquire the temperature T using a temperature sensor in order to evaluate the measurement data. In addition, each liquid has a typical temperature-viscosity characteristic {n (T), T} that depends on its state and that can easily be determined by measuring various viscosity-temperature value pairs {n (T), T} and interpolating. This characteristic can be used alongside the acquisition of the absolute value of the viscosity, e.g. at a fixed temperature, in order to assess the state of the liquid. A determination of the T-η characteristic is particularly easy if, during operation, the liquid is heated and cooled over a large temperature range, as is the case for motor oil, for example.

Currently, for the acquisition of the viscosity pairs of sensors made up of a viscosity sensor and a temperature sensor are used, the two elements being spatially separated from one another and not standing in direct thermal contact with one another. In particular when there are rapid changes in temperature (e.g. during the engine warmup phase) and temperature fluctuations (non-homogenous temperature distribution) in the liquid, the absence of this thermal contact results in a temperature difference between the two sensor elements. This effect is further strengthened by the fact that the two sensor elements react with different speeds to the changes in temperature, due to their different masses and materials. In such a case, the temperature indicated by the temperature sensor therefore does not correspond to the temperature present at the viscosity sensor. The result is a temperature-viscosity measurement value pair that deviates from the true curve of the T-n characteristic, and results in a false interpretation both of the viscosity absolute value and also of the characteristic T-n curve.

An example of this can be seen in FIG. 5. The true curve C1, which in this case is very linear, between temperature T and viscosity measurement signal n(T) is not correctly acquired due to the spatial separation of the viscosity sensor and the temperature sensor, and due to the very different “reaction times.” Given a rapid heating and subsequent cooling, in contrast to the actual linear curve C1 a hysteresis curve C2 is observed. The measured value pairs {n(T), T} lie on the true curve of the T-η curve only at the points at which a matching of the temperatures between the viscosity sensor and the temperature sensor was possible (low temperature gradient at the beginning and at the end of the measurement, as well as shortly before reaching the high temperature).

Other quantities that are important as evaluation criteria for the current state of the liquid include the relative dielectric constant and the conductivity, which can be measured using a capacitive sensor, generally realized by capacitive structures. For these quantities as well, acquisition by separate sensors proves to be disadvantageous. In particular, here as well the temperature differences described above have at least indirect effects on the acquired measurement signals.

### SUMMARY OF THE INVENTION

The viscosity sensor system according to the present invention has, in contrast to the known solutions, the advantage that the described disadvantages resulting from the spatial separation of the sensor elements can be counteracted by a spatial combination of the viscosity sensor and at least one additional sensor in a single sensor element.

The underlying idea of the present invention is to provide, on the surface of the viscosity sensor device, at least one second sensor device for acquiring the at least one additional liquid property, this at least one second sensor device having, on the surface of the viscosity sensor device, electrical contact points for an electrical control device.

According to a preferred development, the piezoelectric viscosity sensor device is formed as a disk-shaped quartz crystal that can be excited to shear oscillations by the electrical control unit, the contact points of the viscosity sensor device being formed on the front side and on the back side of the disk-shaped quartz crystal.

According to a further preferred development, the contact points of the viscosity sensor device leave the front and back side exposed in an edge area, the second sensor device being provided in the edge area.

According to a further preferred development, the second sensor device is provided so as to be electrically insulated at the contact points of the viscosity sensor device.

According to a further preferred development, the electrical contact points are provided so as to be electrically insulated at the contact points of the viscosity sensor device.

According to a further preferred development, the first electrical supply lines are formed as contact springs.

According to a further preferred development, the second electrical supply lines are formed as contact springs.

According to a further preferred development, the first and second contact springs are combined in two-pole contact springs.

According to a further preferred embodiment, the viscosity sensor device is situated in a protective container that has a base and a cap and that can be brought into the liquid.

According to a further preferred development, the first and second electrical supply lines are led out of the protective container through bushings, in particular glass bushings, in the cap and/or the base of the protective container.

According to a further preferred development, the second sensor device is a temperature sensor device.

According to a further preferred development, the second sensor device is a capacitive sensor device.

### BRIEF DESCRIPTION OF THE DRAWINGS

FIG. 1 shows a first specific embodiment of the viscosity sensor system according to the present invention, and its construction.

FIG. 2 shows a second specific embodiment of the viscosity sensor system according to the present invention, and its construction.

FIG. 3 shows a third specific embodiment of the viscosity sensor system according to the present invention, and its construction.

FIG. 4 shows a fourth specific embodiment of the viscosity sensor system according to the present invention, and its construction.

FIG. 5 shows a linear true curve C1 and an acquired hysteresis curve C2 of the viscosity, dependent on the temperature, for a pair of separated sensors.

### DETAILED DESCRIPTION

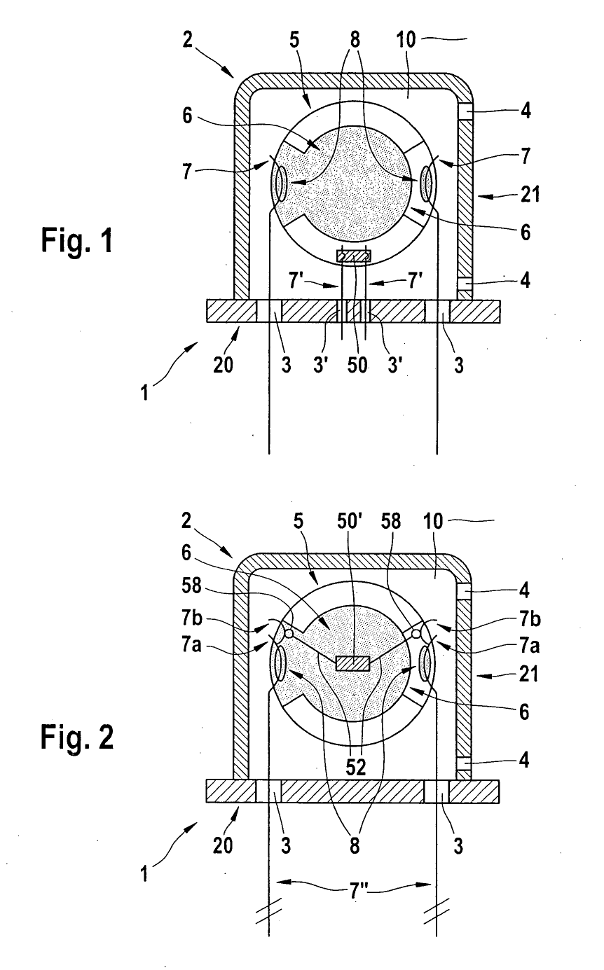

FIG. 1 shows a first specific embodiment of the viscosity sensor system according to the present invention, and its construction.

According to FIG. 1, a container 2 has two parts, being made up of a base 20 and a cap 21 attached detachably thereon, and is situated completely in a liquid 10 that is to be measured. Cap 21 has openings 4, situated laterally and/or at the top, for an exchange of liquid, the opening situated further toward the top being advantageously used as a liquid inlet and the opening situated further toward the bottom being advantageously used as a liquid outlet. Base 20 of container 2 has two pairs of glass bushings 3 and 3′.

As stated above, sensor system 1 is situated as a whole in a liquid 10 whose viscosity and/or other properties are to be measured. Through openings 4, the entire container 2 is thus also filled with liquid 10.

In the present, first exemplary embodiment, oil is used as the liquid 10, the materials used being suitably designed for this exemplary embodiment. However, other liquids, and correspondingly suitable materials, are also possible.

A viscosity sensor 5, for example a piezoelectric quartz crystal, has a disk-shaped construction and is immersed completely in liquid 10 in container 2. Disk-shaped viscosity sensor 5 has two electrical contact points 6, one each on the front side and on the rear side, which according to the present exemplary embodiment are formed as gold or chromium electrodes 6. For use in oil, for example motor oil or gear oil, gold or chromium have proven to be particularly robust materials for these electrodes.

Via a suitable conductive glue 8, contact points 6 are connected to electrical supply lines 7, which according to the present exemplary embodiment are formed as gold-plated or chromium-plated wires. Here as well, for a specific application in oil these gold-plated or chromium-plated wires have proven to be particularly robust conductor materials. Electrical supply lines 7 are additionally formed as slotted contact springs 7 for a mechanical accommodation of the piezoelectric quartz disk.

Conductive glue 8 ensures the electrical and mechanical contacting of piezoelectric quartz disk 5 to contact springs 7 at contact points 6. Isotropically electrically conductive glue 8 is advantageously made of epoxy resin, phenol resin, and/or polyimide according to the present exemplary embodiment. Preferably, the material of conductive glue 8 is also based on an epoxy-phenol base. Isotropic conductive glues 8 are provided with metallic particles, preferably nickel and/or gold particles, in the form of flakes or beads or mixtures thereof. Here, the nickel and/or gold particles have a size of approximately 2 μm to 20 μm. The concentration of the nickel and/or gold particles in conductive glue 8 is approximately 75 to 95 weight %.

Electrical supply lines 7 can be led either directly through base 20 of container 2 using glass bushings 3, or can be connected by suitable connecting techniques, for example welding, to corresponding terminal wires in base 20 of container 2. What is important is that sensor device 5 be connected electrically, via contact points 6 and electrical supply lines 7, to a control/evaluation electronics unit outside container 2 for an electrical controlling of sensor device 5 and a subsequent evaluation of the results, the contact points 6, conductive glues 8, and electrical supply lines 7 being resistant in relation to the measured liquid 10.

In order to achieve the best possible spatial overlap between a temperature sensor 50, for example in the form of a platinum resistor, and viscosity sensor 5, as well as the best possible thermal linkage between the two, temperature sensor 50 is attached directly to the quartz disk of viscosity sensor 5. In the placement of temperature sensor 50, the following is to be observed:

The attaching must result in only a small additional (constant) attenuation of the quartz, temperature sensor 50 must be electrically separated from quartz electrodes 6, and the measurement method must not excite any additional oscillation of the quartz.

For these reasons, in the first exemplary embodiment temperature sensor 50 is situated in the quartz edge area outside the electrode area, where the shear oscillation has already strongly decayed.

Temperature sensor 50 also has two contact points that are contacted via an additional pair of contact springs 7′. Contact springs 7′ are likewise glued to the contact points using a conductive glue, and are led through glass bushings 3′ out of container 2, where the signals of the temperature sensor can be picked off.

FIG. 2 shows a second specific embodiment of the viscosity sensor system according to the present invention, and its construction.

In the second specific embodiment, a temperature sensor 50′ is attached directly on electrode 6, in the center thereof, which is particularly advantageous for thermoelements and thin-film resistors. For the electrical insulation, an insulating layer (not shown) is provided between electrode 6 and temperature sensor 50′.

The electrical linkage of temperature sensor 50′ here takes place via printed conductors 52 that are insulated from electrode 6 and that end in contact points 58. In this second exemplary embodiment, contact springs 7″ are formed with two leads, and each have two contact areas 7a, 7b, contact areas 7a contacting electrodes 6 and contact areas 7b contacting contact areas 58. Contact areas 7a, 7b are likewise glued to the corresponding contact points using a conductive glue. In this way, the signals of viscosity sensor 5 and of temperature sensor 50′ can be led outside container 2 via a single pair of contact springs 7″ for further processing.

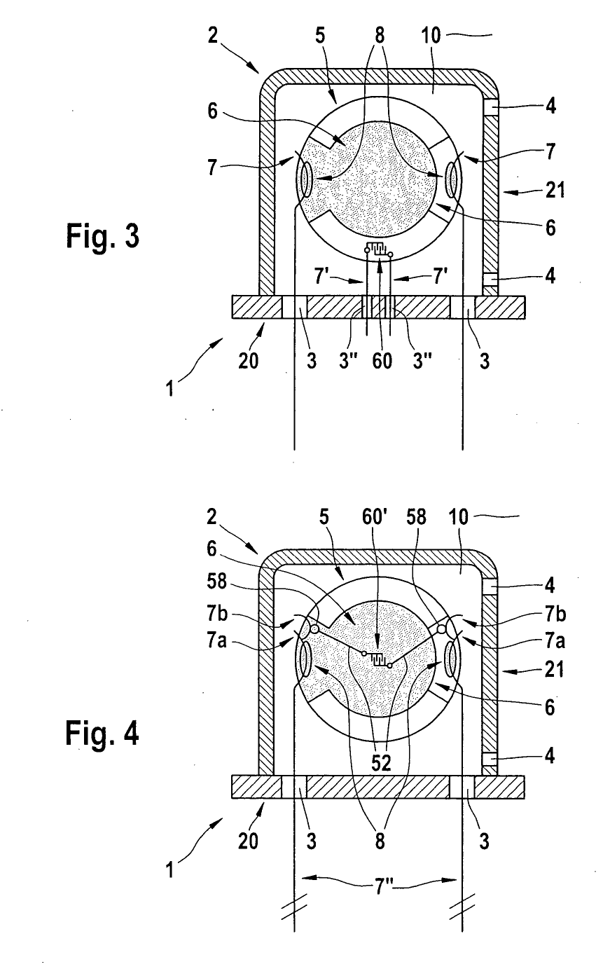

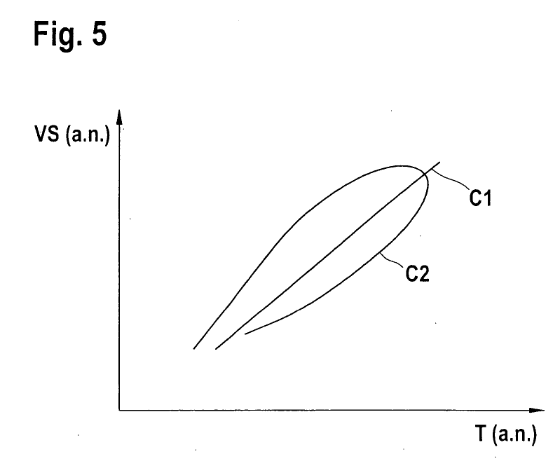

FIG. 3 shows a third specific embodiment of the viscosity sensor system according to the present invention, and its construction.

In the third specific embodiment, instead of temperature sensor 50 of the first specific embodiment, a capacitive sensor 60 is attached in the quartz edge area outside the electrode area, where the shear oscillation has already strongly decayed. In addition, instead of contact springs 3′, flexible terminal wires 3′ are provided for the connection of capacitive sensor 60.

In other respects, the third specific embodiment is identical to the first specific embodiment.

FIG. 4 shows a fourth specific embodiment of the viscosity sensor system according to the present invention, and its construction.

In the fourth specific embodiment, instead of temperature sensor 50′ of the second specific embodiment, a capacitive sensor 60′ is attached directly on electrode 6 in insulated fashion, in the center thereof.

In other respects, the fourth specific embodiment is identical to the second specific embodiment.

Although the present invention has been described above on the basis of a preferred specific embodiment, it is not limited to this embodiment, but rather can be modified in many ways.

Thus, liquids other than oil can be measured, in which case contact point materials, conductive glues having corresponding metal particles, and electrical supply line materials are to be used that are resistant in relation to this liquid.

As a further variant, a placement of an additional sensor on the contact springs or on the base plate of the quartz resonator is also conceivable.

For all variants, various temperature sensors may be used: e.g., temperature-dependent resistors (e.g. platinum thin-film resistors) or thermoelements. In addition, it is also conceivable to realize the temperature sensor directly by applying a metallization on the quartz substrate whose electrical resistance varies with the temperature.

Other capacitive sensors may also be used.

The present invention is also not limited to the depicted attachment locations of the additional sensors. It must merely be ensured that the additional sensor negatively influences neither the electrical controlling nor the mechanical resonance characteristics of the viscosity sensor.

It is also conceivable to provide more than two sensors in addition to the viscosity sensor, e.g. a threefold combination of a viscosity sensor, a temperature sensor, and a capacitive sensor.

In the above description, the quartz was situated in a protective holder having a cap and a base plate. This is not absolutely necessary. It is also conceivable to immerse the quartz completely in the liquid without a cap, or without a cap and base plate. A bushing leading to a liquid-free external chamber can also be realized under the base plate, or an additional contact point can be provided between the legs of the contact spring and an additional bushing to the external chamber.

Finally, the use of contact springs as contact elements is not absolutely necessary.

### LIST OF REFERENCE CHARACTERS

1 viscosity sensor system
2 container
3, 3′ glass bushings
4 openings
5 quartz sensor
6 contact points
7, 7′ contact springs
7′ flexible wires
7a,7b contact areas
8 conductive glue
10 liquid
20 base
21 cap
50, 50′ temperature sensor
60, 60′ capacitive sensor
52 printed conductors
58 contact points

1-12. (canceled)

13. A viscosity sensor system for measuring a viscosity of a liquid and at least one additional property of the liquid, comprising:
a piezoelectric viscosity sensor device that is situated completely in the liquid that is to be measured and that has on a surface thereof first electrical contact points for an electrical controlling of volume oscillations, the first contact points being resistant in relation to the liquid;
first electrical supply lines that are resistant in relation to the liquid and that are connected on the one hand to a control/evaluation electronics unit outside the liquid and on the other hand to the first contact points on the surface of the viscosity sensor device; and
a second sensor device for acquiring the at least one additional property of the liquid, the second sensor device being provided on the surface of the viscosity sensor device and including second electrical contact points on the surface of the viscosity sensor device for an electrical controlling, the second contact points being resistant in relation to the liquid; and
second electrical supply lines that are resistant in relation to the liquid and that are connected on the one hand to the control/evaluation electronics unit outside the liquid and on the other hand to the second contact points.

14. The viscosity sensor system as recited in claim 13, further comprising:
an electrical control unit, wherein:
the piezoelectric viscosity sensor device includes a disk-shaped quartz crystal that can be excited to shear oscillations by the electrical control unit, and
the first contact points of the viscosity sensor device are formed on a front side and on a rear side of the disk-shaped quartz crystal.

15. The viscosity sensor system as recited in claim 14, wherein:
the first contact points of the viscosity sensor device leave the front side and the rear side exposed in an edge area, and
the second sensor device is provided in the edge area.

16. The viscosity sensor system as recited in claim 13, wherein:
the second sensor device is provided in an electrically insulated fashion on the first contact points of the viscosity sensor device.

17. The viscosity sensor system as recited in claim 16, wherein:
the second contact points are provided in an electrically insulated fashion on the first contact points of the viscosity sensor device.

18. The viscosity sensor system as recited in claim 13, wherein:
the first electrical supply lines include contact springs.

19. The viscosity sensor system as recited in claim 18, wherein:
the second electrical supply lines include contact springs.

20. The viscosity sensor system as recited in claim 19, wherein:
the first contact springs and the second contact springs are combined in two-pole contact springs.

21. The viscosity sensor system as recited in claim 13, further comprising:
a container including a base and a cap, wherein:
the viscosity sensor device is situated in the protective container, and
the protective container is capable of being brought into the liquid.

22. The viscosity sensor system as recited in claim 21, further comprising:
bushings, wherein:
the first and second electrical supply lines are led out from the protective container through the bushings in at least one of the cap and the base of the protective container.

23. The viscosity sensor system as recited in claim 22, wherein:
the bushings includes glass bushings.

24. The viscosity sensor system as recited in claim 13, wherein:
the second sensor device includes a temperature sensor device.

25. The viscosity sensor system as recited in claim 13, wherein:
the second sensor device includes a capacitive sensor device.
